(19) United States
(12) Patent Application Publication
(10) Pub. No.: US 2011/0242132 A1
(43) Pub. Date: Oct. 6, 2011

(54) Method for Apparatus for Tattoo Previewing

(76) Inventors: Michael J. Bailey, Hagersville (CA); Jesse Norman Gifford, Ventura, CA (US); Justin Edward Treen, Long Island, NY (US)

(21) Appl. No.: 12/227,859

(22) PCT Filed: May 30, 2007
(86) PCT No.: PCT/CA2007/000960

§ 371 Date: Jan. 25, 2010

Related U.S. Application Data
(60) Provisional application No. 60/808,968, filed on May 30, 2006.

(51) Int. Cl. G09G 5/00

(52) U.S. Cl. 345/630

(57) ABSTRACT

A method and apparatus is provided for allowing an individual to preview how a tattoo will look on their body before they have the design tattooed. By digitally storing images of the individual's body and then overlaying this image with a tattoo design, the individual can modify the tattoo design until they are happy with how it looks.

### CROSS REFERENCE TO RELATED APPLICATIONS

This application claims the benefit of priority of U.S. Provisional Patent Application No. 60/808,968 filed May 30, 2006, which is incorporated herein by reference.

### FIELD OF THE INVENTION

The present invention relates generally to tattoos. More particularly, the present invention relates to a method and apparatus for tattoo previewing.

### BACKGROUND OF THE INVENTION

In the tattoo industry, one significant problem is that individuals who decide they wish to get a tattoo also want to see how the tattoo, or design, will look on their body before the design is applied. The individual has to select the design and hope that the design fits on the body without having its look altered or skewed when it is applied.

Currently, a mock design is manually created and then inked onto the individual's body. The individual then determines how the design looks on their body. However, this mock design only has one size and therefore if it is too small or too big, the tattoo artist has to prepare a second mock design that is hopefully the correct size. This process is repeated until the individual is happy with how the design looks on their body. This is a time consuming process especially when multiple mock designs are required.

In other prior art scenarios, the design is drawn directly on the individual's body. Once again, if the size of the design causes the design to look altered or skewed on the user's body, the tattoo artist has to re-draw the design. Once again, this may require the tattoo artist to re-draw the design multiple times.

It is, therefore, desirable to provide a novel method and apparatus for tattoo previewing.

### SUMMARY OF THE INVENTION

It is an object of the present invention to obviate or mitigate at least one disadvantage of previous methods of tattoo previewing.

In a first aspect, the present invention provides a method of displaying a tattoo so that an individual can preview the tattoo on the individual's body comprising retrieving a body image of the individual; overlaying the tattoo over the body image; sensing modifications to the tattoo; and displaying a combination of the modified tattoo and body image as a tattooed body image.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a schematic view of apparatus for tattoo previewing;

FIG. 2 is a flowcharting showing a method of tattoo management;

FIGS. 3 and 3a are flowcharts outlining a method of tattoo previewing.

FIG. 4 is a flowchart outlining a method of importing a design; and

FIG. 5 is a flowchart outlining a method of editing a design.

### DETAILED DESCRIPTION

Generally, the present invention provides a method and system for tattoo previewing.

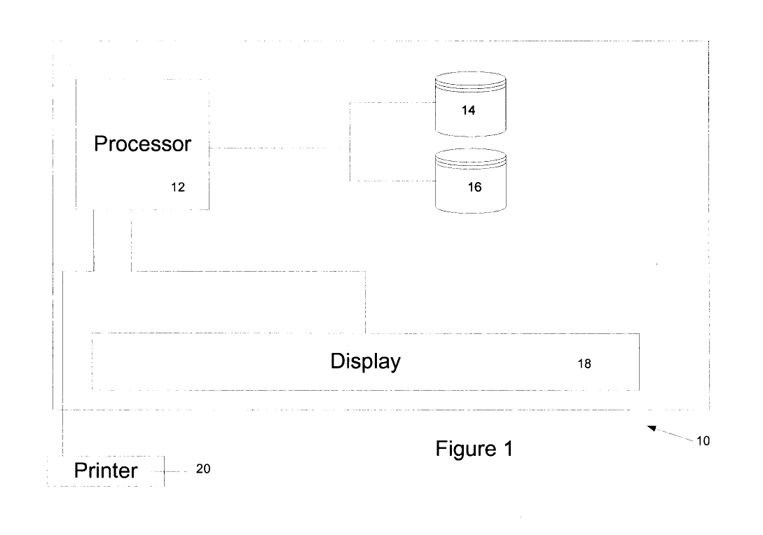

Turning to FIG. 1, a schematic view of apparatus for tattoo management, including tattoo previewing, is shown. The apparatus 10 includes a processor 12, a tattoo, tattoo design, or design, database 14, a body image database 16 and a display 18. In one embodiment, a printer 20 can also be communication with the processor 12.

Although shown as individual databases, the tattoo database 14 and the body image database 16 can be a single database. In one embodiment, the apparatus 10 is located within a single computer. However, in another embodiment, the databases 14 and 16 can be stored on remote servers and the processor 12 communicates with the databases via a network, such as the Internet. In yet a further embodiment, the processor 12 and the databases are located on a remote server whereby the user, or tattoo artist, accesses the processor 12 via a webpage on a computer.

In the following description, the embodiment described is with respect to the apparatus being housed within a single computer to achieve a stand-alone version. However, reference to the processor 12 and the databases 14 and 16 should be understood to also include the embodiments where the processor 12 and the databases 14 or 16 are accessed over a network.

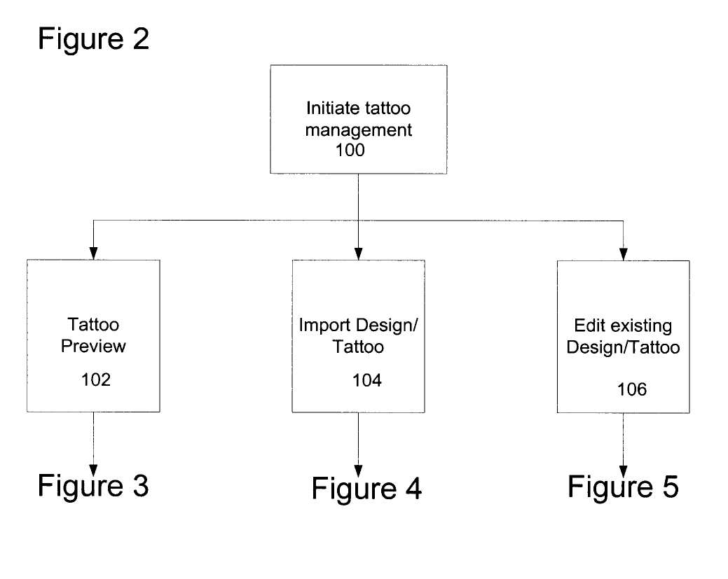

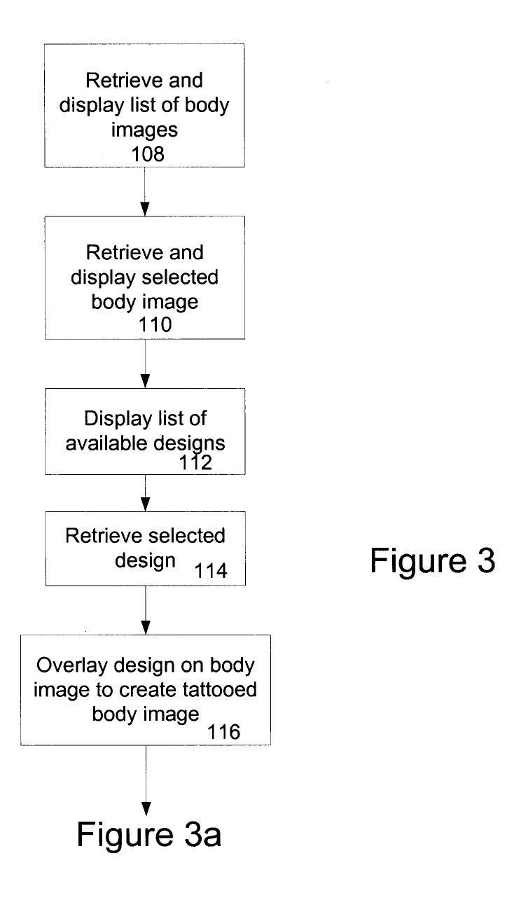

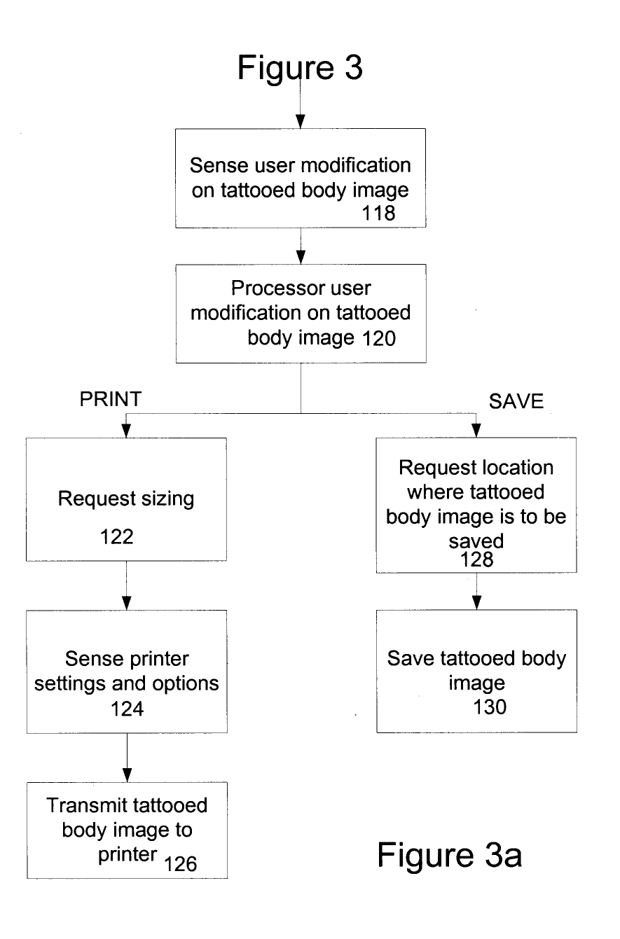

Turning to FIG. 2, a flowchart outlining a method of providing tattoo management is shown. Initially, after a user has initiated the tattoo management apparatus (step 100), the user is provided with a plurality of options on the display 18 including, but not limited to, previewing a tattoo on an individual's body (step 102), importing a tattoo (step 104) or editing a tattoo (step 106). As can be seen from FIG. 2, these individual options are shown in more detail with respect to FIGS. 3 to 5.

Turning to FIGS. 3 and 3a, if the user decides to preview a tattoo to determine how the design, or tattoo, looks on an individual's body, the processor 12 retrieves a list of body images from the body image database 16 and displays this list to the user (step 108). The user of the apparatus can be the tattoo artist or the individual. After the user selects one of the body images from the list, associated with the individual who is requesting the tattoo, the processor retrieves the requested image from the body image database 16 and displays the image on the display 18 (step 110). The body image is typically a digital image of the torso of the individual or a body part of the individual where they wish to have the tattoo applied. The body image is preferably placed in a background layer.

After retrieving and displaying the body image, the user is then prompted to select a design which they wish to apply to the body image via a list provided to the user (step 112). The list is preferably associated with the designs in the tattoo database but may also be retrieved from sources available over a network, such as the Internet. The list can include graphics or can be a text listing of all the available designs. Alternatively, the user can create a new design.

After the design is selected, the processor retrieves the selected design from the tattoo database 14 (step 114), or simply retrieves the newly created design, and then places the design over the body image (step 116) creating a tattooed body image. In one embodiment, this is performed using layering so that the body image is placed within the background of the tattooed body image while the design is in the foreground or a layer on top of the background. The positioning of the design in the foreground (or higher layer) allows the design to be modified and/or manipulated in order for the user to determine how the user wishes for the tattoo to look on the individual's body.

The user can then perform various functions on the tattooed body image which are sensed by the processor 12 (step 118). These functions include, but are not limited to, rotating the body image between landscape/portrait view, moving the design over the body image in order to position the design as desired by the user, scaling the design in order to change the size of the design, rotating the design to change the orientation of the design over the body image, performing a three-dimensional distort on the design, blending the design into the body image or changing the opacity of the design. In each of these steps, the processor 12 senses the modifications and then processes the tattooed body image accordingly (step 120).

After making the modifications, the user can then print or save the tattooed body image. Other options such as canceling the preview or exiting the system without saving can also be selected and performed.

If the user decides to print the tattooed body image, a sizing request is performed by the processor 12 (step 122) to determine the size of the picture that the user wishes to print. After receiving the sizing information from the user, printer options and settings are set by the user and recognized by the processor 12 (step 124) and the tattooed body image is then transmitted by the processor to the printer (step 126) for printing. The tattooed body image can then be saved.

If the user decides to save the tattooed body image, a prompt is provided to the user to request the location where the user wishes to save the tattooed body image (step 128). The processor then proceeds to save the tattooed body image in the designated location (step 130). This may be within one of the databases 14 or 16 or in a separate database, or memory store, such as a disk or a removable hard drive. As will be understood, the steps of saving the tattooed body image can be performed prior to printing.

As will be understood, one body image can have multiple designs and therefore, the above steps can be repeated for each design that the individual wishes to have placed on their body image.

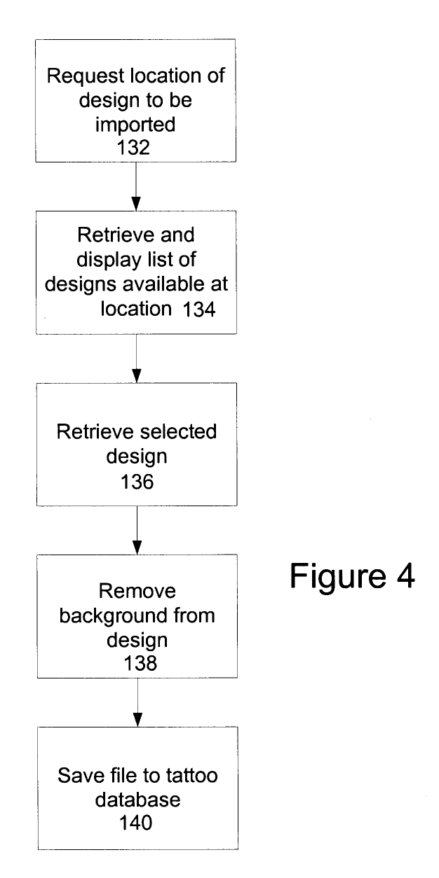

Turning to FIG. 4, if the user decides to import a design, or a picture which will become a design (step 104), the processor 12 senses this selection and requests the user to enter a location such as a directory (for the stand alone embodiment) or URL (for the networked embodiment) where the design, or picture, to be imported is currently stored (step 132). Alternatively, the user can access the directory to select the actual design or picture. Once the user has entered the location, the processor 12 accesses the location and retrieves a list of designs which are available at the specified location and displays the list to the user (step 134). After sensing the selection by the user, the processor retrieves the selected design and displays the design to the user (step 136). The background of the design is then removed (step 138). The removal of the background allows a picture to be changed to a tattoo to change a raster image to a vector image. After removing the background, the design is then saved to the tattoo database 14 (step 140) in a predetermined file format, such as a Portable Network Graphics (PNG) format. PNG format is used since the PNG format enables storage and management of the design with little, if any, modification to the original file or picture. After being stored in the tattoo database 14, the design is then available for use in future previews.

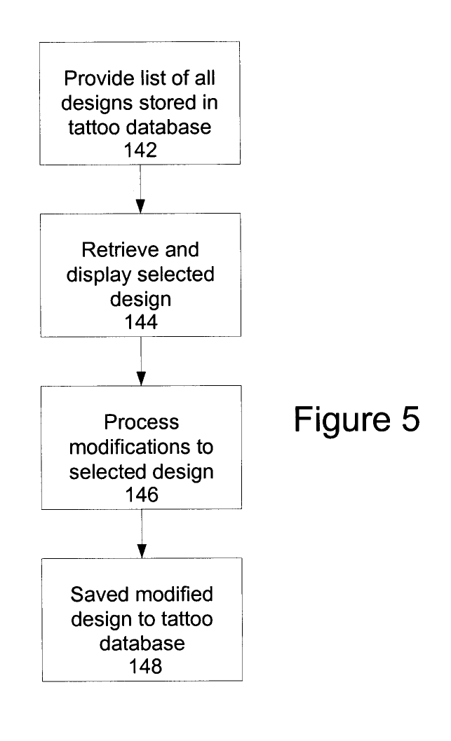

Turning to FIG. 5, if the user decides to edit an existing design which is previously stored in the tattoo database 14 (step 106), the processor 12 provides a listing of all the designs stored in the tattoo database 14 to the user (step 142). After sensing user selection, the processor 12 retrieves the requested design from the tattoo database 14 (step 144). The user can then perform modifications on the design, including but not limited to, scaling the design in order to change the size of the design, rotating the design to change the orientation of the design or change the opacity of the design. The processor 12 senses and monitors all of the modifications to the selected design (step 146) and processes the design accordingly. After the user is finished and wishes to save the design, the processor 12 saves the modified design (step 148) back to the database 14, preferably in the PNG format. The modified design may replace the original design or it may simply be saved as a new design.

An advantage of the invention is that since the designs, or tattoos, are stored in a digital format, they can be scaled so that an arm-sized tattoo can be quickly transformed into a back tattoo without having to manually re-draw and re-size the entire design.

Another advantage of the invention is that the tattooing process is accelerated since the tattoo previewing process is improved. The user, or tattoo artist does not have to manually draw multiple copies of mock designs until the a correctly sized design is determined. Also, digital tattoo information, such as the designs, can be stored and managed.

In another embodiment, the apparatus can include the functionality to generate and print stencil ready artwork from tattoo artist drawings with complete control over the size and aspect ratio. In yet another embodiment, a ‘Digital Light Box’ may be included to aid in stencil creation and tattoo editing while retaining old school techniques of using a pen.

In the above description, for purposes of explanation, numerous details have been set forth in order to provide a thorough understanding of the present invention. However, it will be apparent to one skilled in the art that these specific details are not required in order to practice the present invention. In other instances, well-known electrical structures and circuits are shown in block diagram form in order not to obscure the present invention.

Embodiments of the invention may be represented as a software product stored in a machine-readable medium (also referred to as a computer-readable medium, a processor-readable medium, or a computer usable medium having a computer readable program code embodied therein). The machine-readable medium may be any suitable tangible medium, including magnetic, optical, or electrical storage medium including a diskette, compact disk read only memory (CD-ROM), memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine readable medium may interface with circuitry to perform the described tasks.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method of displaying, in a digital domain, a tattoo so that an individual can preview the tattoo on the individual's body comprising:
retrieving a body image of the individual;
overlaying the tattoo over the body image;
sensing modifications to the tattoo; and
displaying a combination of the modified tattoo and body image as a tattooed body image.

2. The method of claim 1 further comprising, after the step of retrieving, the step of:
placing the body image in a background layer.

3. The method of claim 2 wherein the step of overlaying comprises:
receiving a request for a tattoo;
retrieving the requested tattoo; and
placing the tattoo in a layer above the background layer.

4. The method of claim 1 wherein the step of retrieving comprises:
providing a list of body images to the individual;
sensing selection of one of the body images; and
retrieving the selected body image.

5. The method of claim 4 wherein the selected body image is retrieved from a body image database.

6. The method of claim 1 wherein said modifications are selected from a group consisting of scaling the tattoo, rotating the tattoo, changing the opacity of the tattoo, changing the position of the tattoo, performing a three-dimensional distort on the tattoo and blending the tattoo into the body image.

7. Apparatus for displaying, in a digital domain, a tattoo so that an individual can preview the tattoo on the individual's body comprising:
a tattoo database for storing at least one tattoo;
a body image database for storing at least one body image associated with the individual;
a processor for retrieving the at least one body image and a tattoo and for combining the at least one body image and the tattoo to form a tattooed body image; and
a display for displaying the tattooed body image to the individual.

8. The apparatus of claim 7 wherein the tattooed body image is created by layering the at least one body image and the tattoo.

9. The apparatus of claim 8 wherein the at least one body image is placed in a background layer.

10. The apparatus of claim 9 wherein the tattoo is placed in a layer over the background layer.

11. The apparatus of claim 7 wherein the processor is located on a server remote from the display.

12. The apparatus of claim 11 wherein the processor is accessed over the Internet.

13. The apparatus of claim 7 wherein the tattoo database, the body image database, the processor and the display are stored in a computer.
